(19) United States
(12) Patent Application Publication
(10) Pub. No.: US 2021/0163665 A1
(43) Pub. Date: Jun. 3, 2021

(54) ONE COMPONENT THERMOSETTING EPOXY RESIN COMPOSITIONS

(71) Applicant: SIKA TECHNOLOGY AG, Baar (CH)

(72) Inventor: Dominique GALLO, Otelfingen (CH)

(73) Assignee: SIKA TECHNOLOGY AG, Baar (CH)

(21) Appl. No.: 17/263,464

(22) PCT Filed: Jul. 26, 2019
(86) PCT No.: PCT/EP2019/070177

§ 371 Date: Jan. 26, 2021

(30) Foreign Application Priority Data
Aug. 13, 2018 (EP) 18188754.8

(51) Int. Cl. C08G 18/48; C08G 59/50; C08G 59/40; C08G 59/24; C08G 18/12; C08G 18/24; C08G 18/69; C08G 18/75; C08G 18/80

(52) U.S. Cl. CPC C08G 18/4854; C08G 59/5086; C08G 59/4021; C08G 59/245; C08G 2170/00; C08G 18/246; C08G 18/69; C08G 18/755; C08G 18/8067; C08G 18/12

(57) ABSTRACT

A one-component thermosetting epoxy resin includes compositions that are particularly suitable for the bonding of substrates having different coefficients of thermal expansion, especially in the shell construction of modes of transport or white goods. The one-component thermosetting epoxy resin composition includes a) at least one epoxy resin A having an average of more than one epoxy group per molecule; b) at least one 2,4-diamino-1,3,5-triazine GU containing, in the 6 position, —an alkyl radical having 1 to 20 carbon atoms, in which one hydrogen atom in the α position has been replaced by a 2,4-diamino-1,3,5-triazin-6-yl radical, a cycloalkyl radical having 5 to 12 carbon atoms or -an aryl radical having 6 to 12 carbon atoms; and c) at least one toughness improver D, which is a terminally blocked polyurethane polymer D1.

### TECHNICAL FIELD

The invention relates to the field of thermosetting epoxy resin compositions, especially for the bonding of substrates having different coefficients of thermal expansion, especially in the bodyshell construction of modes of transport or white goods.

### STATE OF THE ART

Thermosetting epoxy resin compositions have long been known. An important field of use of thermosetting epoxy resin compositions is in vehicle construction, especially in bonding in the shell construction of modes of transport or white goods. In both cases, after the application of the epoxy resin composition, the bonded article is heated in an oven, which also cures the thermosetting epoxy resin composition.

If two substrates having different coefficients of linear thermal expansion are bonded to one another by structural bonding, the result of heating in the oven at temperatures of 100-220° C. is that the two substrates expand to different lengths. The subsequent cooling thus gives rise to a high stress in the cured epoxy resin composition, which leads either to failure of the adhesive bond, to deformation of the substrates, or to “freezing” of the stress in the adhesive bond. As a result of such “freezing”, the adhesive bond during its lifetime is significantly more sensitive to static, dynamic and shock stresses, which can lead to weakening of the adhesive bond.

In the case of bonding in the shell construction of modes of transport, the bonded components are typically heated at least three times in an oven. The first heating of the bonded component serves to cure the cathodic electrocoat in the cathodic electrocoating oven. Thereafter, (a) further coating(s) that serve(s) to compensate for unevennesses and to promote adhesion is/are typically applied to the cured cathodic electrocoat, and cured in a second oven. This is followed by the application of the clearcoat and curing of the clearcoat in a third oven. It is typically the first oven that has the highest temperature, typically between 140-200° C. “Frozen” stresses in the adhesive bond are therefore absorbed by the components particularly in the first heating step, which is particularly disadvantageous for the two subsequent heating steps owing to the additional stresses in the adhesive bond in the further cooling phases.

There is therefore a need for thermosetting epoxy resin compositions for structural bonding of substrates having different coefficients of thermal linear expansion, which firstly have adequate mechanical properties for structural bonding and secondly withstand the high stresses that occur in the case of repeated heating without failure of the structural bond.

### SUMMARY OF THE INVENTION

It is therefore an object of the present invention to provide thermosetting epoxy resin compositions suitable for structural bonding of substrates having different coefficients of linear thermal expansion, which firstly have adequate mechanical properties for structural bonding and secondly assure bonding in spite of the high stresses that occur in the case of repeated heating without failure of the structural bond.

This object was surprisingly achievable by an inventive use as claimed in claim 1.

Further aspects of the invention are the subject of further independent claims. Particularly preferred embodiments of the invention are the subject of the dependent claims.

### Ways of Executing the Invention

The present invention relates to a one-component thermosetting epoxy resin composition comprising
a) at least one epoxy resin A having an average of more than one epoxy group per molecule;
b) at least one 2,4-diamino-1,3,5-triazine GU containing, in the 6 position,
   an alkyl radical having 1 to 20 carbon atoms, in which one hydrogen atom in the α position has been optionally replaced by a 2,4-diamino-1,3,5-triazin-6-yl radical,
   a cycloalkyl radical having 5 to 12 carbon atoms or
   an aryl radical having 6 to 12 carbon atoms;
c) at least one toughness improver D, which is a terminally blocked polyurethane polymer D1.

The weight ratio of the at least one epoxy resin A having an average of more than one epoxy group per molecule to the at least one toughness improver D is 0.4-3.3.

In this document, the use of the term “independently” in connection with substituents, radicals or groups should be interpreted such that the substituents, radicals or groups having the same designation in the same molecule may occur simultaneously with different meanings.

In this document, a “toughness improver” is understood to mean an addition to an epoxy resin matrix that results in a distinct increase in toughness even in the case of small additions of 5% by weight, especially 10% by weight, based on the total weight of the epoxy resin compositions and is thus capable of absorbing higher flexural, tensile, impact or shock stress before the matrix cracks or breaks.

The prefix “poly” in substance names such as “polyol”, “polyisocyanate”, “polyether” or “polyamine” in the present document indicates that the respective substance formally contains more than one of the functional group that occurs in its name per molecule.

In the present document, “molecular weight” is understood to mean the molar mass (in grams per mole) of a molecule. “Average molecular weight” is understood to mean the number-average molecular weight Mn of an oligomeric or polymeric mixture of molecules, which is typically determined by means of GPC against polystyrene as standard.

A “primary hydroxyl group” refers to an OH group bonded to a carbon atom having two hydrogens.

In the present document, the term “primary amino group” refers to an NH₂ group bonded to one organic radical, while the term “secondary amino group” refers to an NH group bonded to two organic radicals which may also together be part of a ring. Accordingly, an amine having one primary amino group is referred to as “primary amine”, one having a secondary amino group correspondingly as “secondary amine”, and one having a tertiary amino group as “tertiary amine”.

In the present document, “room temperature” refers to a temperature of 23° C.

### Description of Test Method for the Level of Force

If two substrates, for example metals or fiber-reinforced plastics, having different coefficients of linear thermal expansion (a) are bonded to one another by structural bonding, especially in bodyshell construction, the result of heating steps in the oven at temperatures of 100-220° C., for example while passing through a convection oven, is that the two substrates expand to different lengths. The subsequent cooling, for example while passing through cooling zones, thus gives rise to high stress in the partly or fully cured epoxy resin composition, which leads either to failure of the adhesive bond, to deformation of the substrates, or to “freezing” of the stress in the adhesive bond.

In order to be able to better examine the characteristics of cured epoxy resin compositions, a laboratory method for assessment of the tolerance thereof to “Δα-induced” stresses was developed.

Rather than inducing stress by means of a linear thermal expansion, which would require test specimens having similar dimensions to real bodywork components, the “Δα stress” in the laboratory method was applied to a lap shear specimen via a tensile tester. The temperature profile in the convection oven was simulated by two thermocouples that enable temperature control of the lap shear specimen in the region of the bonding surface with defined heating and cooling rates. Since the cooling phase is the most critical, a stress was applied via the tensile tester only during the cooling in this test. According to the strain rate setting on the tensile tester, it is thus possible to simulate variable stress scenarios that would arise with different substrate combinations.

Test Specimens Used and Preparation Thereof

For the simulation of “Δα-induced” stresses, lap shear specimens that were produced as follows from galvanized steel sheet (thickness 1.5 mm, yield point 420 MPa) were used:

Preparation:

1.) Clean steel sheet (25 mm×100 mm×1.5 mm) with heptane and then oil in a defined manner with 3 g/m² of Anticorit PL3802-39S (deep drawing oil, FUCHS Schmierstoffe GmbH).

2.) Bound bonding area (10 mm×25 mm) with Teflon spacers (thickness 1.5 mm) and apply epoxy resin composition.

3.) Join sheets and laterally fix bonding area with one clamp on each side.

4A.) Simulation of the cure state after cathodic electrocoating oven (1st cure); the lap shear samples are heat-treated at 175° C. for 35 min (dwell time) to simulate heating in the cathodic electrocoating oven,

or

4.B) Simulation of the cure state after passing through all process ovens (3rd cure, process cure); for simulation of the cure state after passing through al process ovens (after 1st, 2nd and 3rd cure), the lap shear samples are subjected to the following heat treatment:
35 min (dwell time) at 175° C. (1st cure, simulation of cathodic electrocoating oven), followed by cooling to 23° C.,
35 min (dwell time) at 160° C. (2nd cure, simulation of primer-surfacer oven), followed by cooling to 23° C.,
35 min (dwell time) at 165° C. (3rd cure, simulation of clearcoat oven), followed by cooling to 23° C.

5.) In the case of 4A.), the Teflon spacer is removed after the samples have cooled. In the case of 4B.), the Teflon spacer is not removed until after the 3rd heating step, after cooling.

Determination of Parameters

As already mentioned, it is possible by this test method to simulate various Δα-induced stress scenarios via the setting of the strain rate to which the lap shear specimen is subjected. Using the example of a material combination consisting of aluminum on steel (Δα=13*10⁻⁶K⁻¹), the necessary strain rate is to be subsequently calculated taking account of equations (1) and (2).

Thermal expansion of solid bodies in a linear approximation

ΔL=L₀*α*ΔT Equation (1)

ΔT=T₂−T₁ Equation (2)

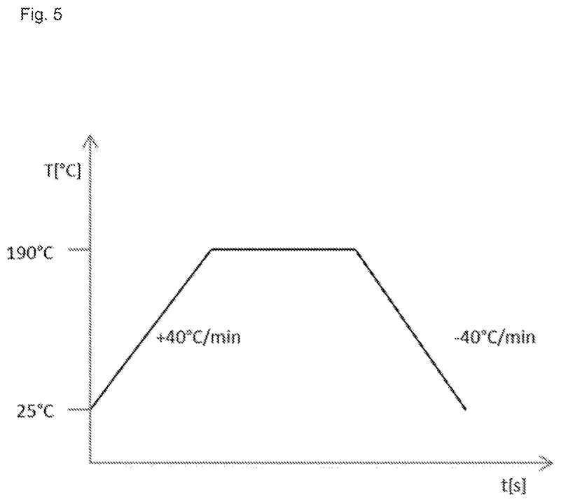

The starting length L₀ of the two joining partners is to be 1000 mm. In accordance with standard temperature progressions in convection ovens, the temperature profile shown in FIG. 5 was defined for heating and cooling of the samples (in the case of 1st cure). This results in starting temperature and final temperature T₁/T₂ and the temperature differential AT. Heating and cooling rates were likewise chosen as values typical in the automotive industry of 40° C./min.

L₀=1000 mm

α_{Stahl}=10.8*10⁻⁶ [K⁻¹]

α_{Alu}=23.8*10⁻⁶ [K⁻¹]

ΔT=165 [K] for 1st cure,ΔT=140 [K] for 3rd cure

T₂=190[° C.] for 1st cure,T₂=165[° C.] for 3rd cure

T₁=25[° C.]

ΔL_{Stahl}=1000 mm*10.8*10⁻⁶ K⁻¹*165 K=1.782 mm for 1st cure

ΔL_{Stahl}=1000 mm*10.8*10⁻⁶ K⁻¹*140 K=1.512 mm for 3rd cure Equation (4)

ΔL_{Alu}=1000 mm*23.8*10⁻⁶ K⁻¹*165 K=3.927 mm for 1st cure

ΔL_{Alu}=1000 mm*23.8*10⁻⁶ K⁻¹*140 K=3.332 mm for 3rd cure Equation (5)

The coefficients of thermal expansion for steel α_{Stahl} and aluminum α_{Alu} were taken from the literature. If the defined values are inserted into equations 1 and 2, the thermal expansion ΔL for steel and aluminum is obtained according to equations 4 and 5. During the heating phase, this results in a respective linear expansion differential of 2.145 mm and 1.820 mm by which aluminum expands more significantly than steel. Correspondingly, the cured epoxy resin composition that forms a cohesive bond must compensate for a respective shrinkage differential of likewise 2.145 mm and 1.820 mm during the cooling phase. Taking account of the cooling rate V_{A} of 40° C./min, according to equations 6 and 7, a strain rate V_{Zug} of 0.52 mm/min is thus found.

$$\begin{matrix} {V}_{Zug} = ( Δ {L}_{Alu} - Δ {L}_{Stahl} ) * \frac{{V}_{A}}{( {T}_{2} - {T}_{1} )} & Equation ( 6 ) \\ {V}_{Zug} = ( 3.927 mm - 1.782 mm ) * \frac{40 {°}_{min}^{C .}}{( 190 ° C . - 25 ° C . )} = 0.52 mm / min for 1 st cure & Equation ( 7 ) \\ {V}_{Zug} = ( 3.332 mm - 1.512 mm ) * \frac{40 {°}_{min}^{C .}}{( 165 ° C . - 25 ° C . )} = 0.52 mm / min for 3 rd cure & \end{matrix}$$

Performance of a Measurement:

1.) A lap shear specimen prepared according to the above-described preparation instructions is clamped in a tensile tester. At first, however, only the lower clamp jaw is fixed. The clamped length is 100 mm.

2.) Both thermocouples are pressed onto the sample, such that they are in contact with the bonding surface.

3.) The starting and final temperatures on the control unit are set to 25° C. and to 190° C. and 165° C. respectively. The input for heating and cooling rates is 40° C./min.

4.) The heating phase is started.

5.) On attainment of the respective final temperature of 190° C. or 165° C., this is maintained by means of a countdown for 2 min in order to assure uniform heating of the bonding surface.

6.) 30 seconds before the countdown has elapsed, the lap shear specimen is then also fixed by the upper clamp jaw.

7.) When the countdown has elapsed, the cooling phase is started automatically. At the same time, a lap shear test with a strain rate of 0.52 mm/min is started manually by means of the tensile tester control software.

Measurement Results and Evaluation

The measurement result determined was the level of force at the end of the cooling phase, i.e. on attainment of a longitudinal expansion of 2.145 mm for the 1st cure or 1.820 mm for the 3rd cure. The higher the level of force, the more frozen stresses are to be expected in the epoxy resin composition and irreversible deformations in the substrates. Correspondingly, as low as possible a level of force is an advantageous result here (“more Δα tolerant”).

The lap shear sample was cooled from 190° C. for the 1st cure, or 165° C. for the 3rd cure, at a cooling rate of 40° C./min to a temperature of 25° C. Measurement in the tensile shear test was effected at a strain rate V_{zug} of 0.52 mm/min. A triple determination was conducted for each epoxy resin composition.

A further point of interest is the juncture of failure. If this happens before the end of the cooling phase, i.e. a fracture occurs at a strain rate L₀=1000 mm and Δα=13*10⁻⁶K⁻¹ of 0.52 mm/min prior to attainment of a linear expansion of 2.145 mm, or 1.820 mm, the “Δα tolerance” of the epoxy resin composition is regarded as disadvantageous since such an epoxy resin composition would lead to component failure in a real application with (L₀=1000 mm and Δα=13*10⁻⁶K⁻¹). By contrast, if the fracture occurs at elongations of 2.145 mm, or >1.820 mm, this is considered to be preferred “Δα tolerance”. The higher the linear expansion, the better the “Δα tolerance”.

The lap shear test is a lap shear test for determining lap shear strength to DIN EN 1465.

Preferably, the level of force measured is s 6000 N, preferably ≤5000 N, preferably ≤4500 N, preferably ≤4000 N, preferably ≤3500 N, preferably ≤3000 N, preferably ≤2500 N, preferably ≤2000 N.

The epoxy resin A having an average of more than one epoxy group per molecule is preferably a liquid epoxy resin or a solid epoxy resin. The term “solid epoxy resin” is very well known to a person skilled in the art of epoxies and is used in contrast to “liquid epoxy resins”. The glass transition temperature of solid resins is above room temperature, meaning that they can be comminuted at room temperature to give free-flowing powders.

Preferred epoxy resins have the formula (II)

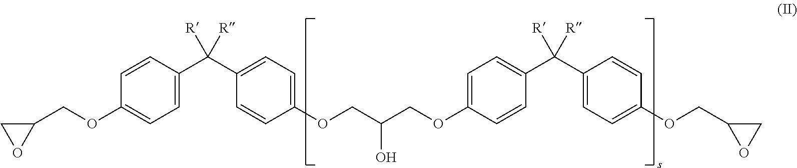

The substituents R′ and R″ here are independently either H or CH₃.

In solid epoxy resins, the index s has a value of >1.5, especially of 2 to 12.

Such solid epoxy resins are commercially available, for example from Dow or Huntsman or Hexion.

Compounds of the formula (II) having an index s of 1 to 1.5 are referred to as semisolid epoxy resins by the person skilled in the art. For the present invention here, they are likewise considered to be solid resins. However, preferred solid epoxy resins are epoxy resins in the narrower sense, i.e. where the index s has a value of >1.5.

In liquid epoxy resins, the index s has a value of less than 1. Preferably, s has a value of less than 0.2.

Preference is thus given to diglycidyl ethers of bisphenol A (DGEBA), of bisphenol F, and of bisphenol A/F. Such liquid resins are available, for example, as Araldite® GY 250, Araldite® PY 304, Araldite® GY 282 (Huntsman) or D.E.R.™ 331 or D.E.R.™ 330 (Dow) or Epikote 828 (Hexion).

Further preferable epoxy resins A are what are called epoxy novolaks. These especially have the following formula:

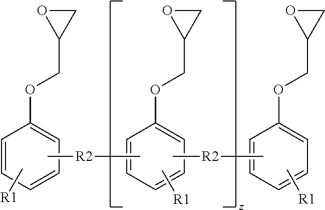

with R2=

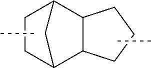

or CH₂, R1═H or methyl and z=0 to 7.

More particularly, these are phenol or cresol epoxy novolaks (R2═CH₂).

Such epoxy resins are commercially available under the EPN or ECN and Tactix® trade names from Huntsman or from the D.E.N.™ product series from Dow Chemical.

More preferably, the epoxy resin A is a liquid epoxy resin of the formula (II).

In a very particularly preferred embodiment, the thermosetting epoxy resin composition contains both at least one liquid epoxy resin of the formula (II) with s<1, especially less than 0.2, and at least one solid epoxy resin of the formula (II) with s>1.5, especially from 2 to 12.

The proportion of the epoxy resin A is preferably 10-60% by weight, especially 30-50% by weight, based on the total weight of the epoxy resin composition.

It is further advantageous when 60-100% by weight, especially 60-80% by weight, of the epoxy resin A is an aforementioned liquid epoxy resin of the formula (II).

It is further advantageous when 0-40% by weight, especially 20-40% by weight, of the epoxy resin A is an aforementioned solid epoxy resin of the formula (II).

The epoxy resin A is preferably not a reactive diluent G as described hereinafter.

The one-component thermosetting epoxy resin composition comprises b) at least one 2,4-diamino-1,3,5-triazine GU containing, in the 6 position,
an alkyl radical having 1 to 20 carbon atoms, in which one hydrogen atom in the α position has been optionally replaced by a 2,4-diamino-1,3,5-triazin-6-yl radical,
a cycloalkyl radical having 5 to 12 carbon atoms or
an aryl radical having 6 to 12 carbon atoms.

This is advantageous over one-component thermosetting epoxy resin compositions that are cured with dicyandiamide in that significantly lower moduli of elasticity are obtained after a first cure. This is apparent, for example, in table 4 in the comparison of Z1 and Z2 with Z3-Z5. However, the values for modulus of elasticity after the 3rd cure are comparable to Z1 and Z2. Moreover, the values for elongation at break and especially the values for tensile strength and lap shear strength are comparable with the values of Z1 and Z2.

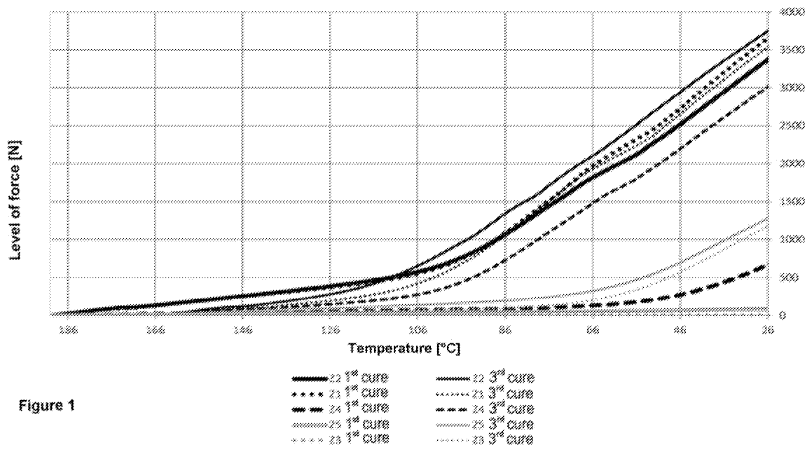

It is further apparent from FIG. 1 that Z2, compared to Z3-Z5, after a first cure has a significantly higher residual stress/level of force. Especially after the first cure, the difference in the level of force of Z2 compared to Z3-Z5 is particularly marked.

The at least one 2,4-diamino-1,3,5-triazine (GU) is preferably selected from the list consisting of
6-methyl-2,4-diamino-1,3,5-triazine (acetoguanamine),
6-ethyl-2,4-diamino-1,3,5-triazine (propioguanamine),
6-propyl-2,4-diamino-1,3,5-triazine (butyroguanamine),
6-isopropyl-2,4-diamino-1,3,5-triazine (isobutyroguanamine),
6-nonyl-2,4-diamino-1,3,5-triazine (caprinoguanamine),
6-heptadecyl-2,4-diamino-1,3,5-triazine (palmitinguanamine),
6-cyclopentyl-2,4-diamino-1,3,5-triazine,
6-cyclohexyl-2,4-diamino-1,3,5-triazine,
6-cyclohexylmethyl-2,4-diamino-1,3,5-triazine,
6-methylcyclohexyl-2,4-diamino-1,3,5-triazine,
6-phenyl-2,4-diamino-1,3,5-triazine (benzoguanamine),
6-(3-pyridyl)-2,4-diamino-1,3,5-triazine,
6-benzyl-2,4-diamino-1,3,5-triazine (phenylacetoguanamine),
6-tolyl-2,4-diamino-1,3,5-triazine,
6-ethyl-2,4-diamino-1,3,5-triazine,
6,6′-ethylenebis(1,3,5-triazine-2,4-diamine) (succinoguanamine) and
6,6′-(butane-1,4-diyl)bis(1,3,5-triazine-2,4-diamine) (adipoguanamine).

Preferably, the at least one 2,4-diamino-1,3,5-triazine (GU) is a 2,4-diamino-1,3,5-triazine (GU) containing, in the 6 position,
an alkyl radical having 1 to 20 carbon atoms, especially 1 to 10 carbon atoms, 1 to 9 carbon atoms, 1 to 3 carbon atoms, more preferably 1 carbon atom, in which there is a hydrogen atom in the α position; or
an aryl radical having 6 to 12 carbon atoms, especially 6-7 carbon atoms, more preferably 6 carbon atoms.

More preferably, the at least one 2,4-diamino-1,3,5-triazine (GU) is a 2,4-diamino-1,3,5-triazine (GU) containing, in the 6 position, an alkyl radical having 1 to 20 carbon atoms, especially 1 to 10 carbon atoms, 1 to 9 carbon atoms, 1 to 3 carbon atoms, more preferably 1 carbon atom, in which there is a hydrogen atom in the α position.

Table 4 shows, from the comparison of Z1 and Z2 with Z3-Z5, that particularly high values for impact peel strength at −30° C. and for angular peel strength are obtained as a result.

The at least one 2,4-diamino-1,3,5-triazine (GU) is more preferably selected from the list consisting of
6-nonyl-2,4-diamino-1,3,5-triazine (caprinoguanamine),
6-phenyl-2,4-diamino-1,3,5-triazine (benzoguanamine) and
6-methyl-2,4-diamino-1,3,5-triazine (acetoguanamine),
especially preferably
6-phenyl-2,4-diamino-1,3,5-triazine (benzoguanamine) and
6-methyl-2,4-diamino-1,3,5-triazine (acetoguanamine),
most preferably
6-methyl-2,4-diamino-1,3,5-triazine (acetoguanamine).

The molar ratio of the molar amount of 2,4-diamino-1,3,5-triazine GU to the molar amount of epoxy groups in the epoxy resin A is preferably 3.8-4.2, especially 3.9-4.1.

The ratio of the total amount of 2,4-diamino-1,3,5-triazine GU plus, if appropriate, the total amount of dicyandiamide to the total amount of epoxy groups in the epoxy resin A is preferably 80%-120%, especially 90%-110%, more preferably 95%-105%, of a ratio needed for stoichiometric curing. For this purpose, a curing agent functionality of 4 is assumed for 2,4-diamino-1,3,5-triazine GU, and a curing agent functionality of 5.5 for dicyandiamide.

If the at least one 2,4-diamino-1,3,5-triazine (GU) is 6-phenyl-2,4-diamino-1,3,5-triazine (benzoguanamine), this is advantageous in that both high values for −30° C. impact peel strength and angular peel strength and particularly low values for the level of force are obtained as a result. This is apparent, for example, in the comparison of Z3 with Z4-5 in table 4 and in FIG. 1.

It may further be advantageous when the at least one 2,4-diamino-1,3,5-triazine (GU) is 2,4-diamino-1,3,5-triazine (GU) containing, in the 6 position, an aryl radical having 6 to 12 carbon atoms, especially 6-7 carbon atoms, more preferably 6 carbon atoms, and the one-component thermosetting epoxy resin composition further comprises dicyandiamide.

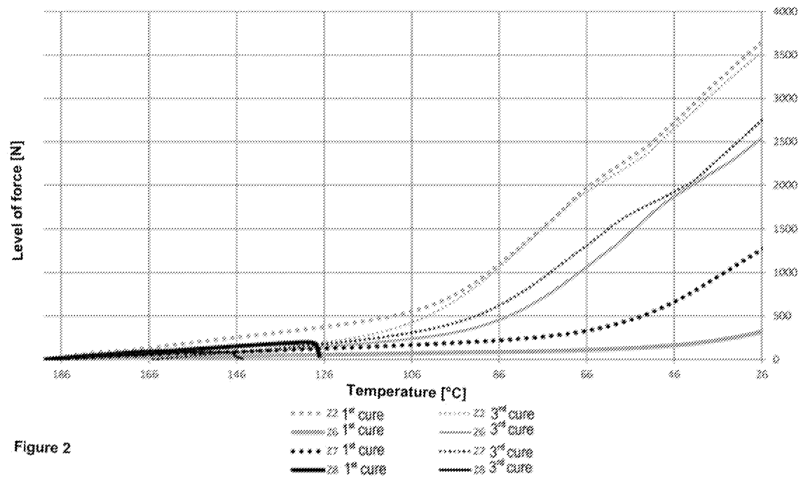

This is beneficial for high values of impact peel strength (23° C., −30° C.) and of angular peel strength. Moreover, this reduces blister formation in the curing adhesive. This is apparent, for example, in table 4 in the comparison of Z6 with Z8 and Z10 and in the comparison of Z6-7 with Z3-5. It is apparent from FIG. 2 that the combination of dicyandiamide with acetoguanamine leads to early adhesive failure.

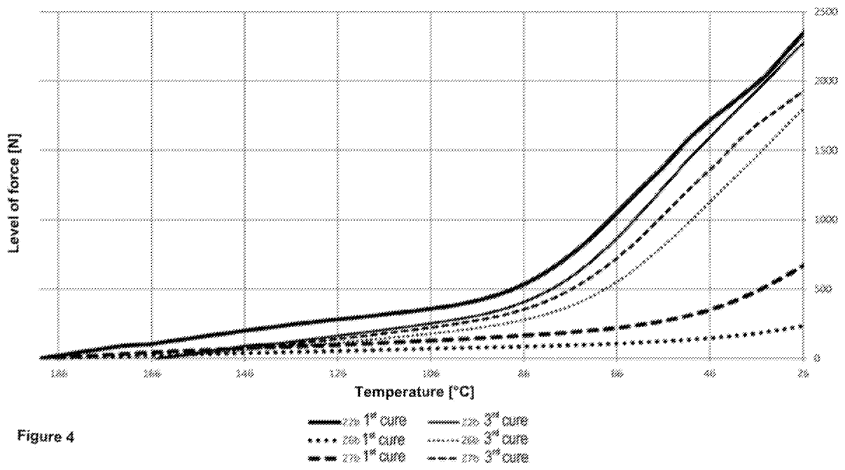

The molar ratio of 2,4-diamino-1,3,5-triazine GU containing an aryl radical having 6 to 12 carbon atoms in the 6 position to dicyandiamide is preferably 9.0-2.0, especially 7.0-3.0, preferably 6.0-4.0. It is apparent from FIG. 2 and FIG. 4 that such a ratio leads to a lower level of force.

It may further be advantageous when the thermosetting epoxy resin compositions of the invention contain less than 10% by weight, less than 5% by weight, especially less than 1% by weight, preferably less than 0.5% by weight, more preferably less than 0.3% by weight, most preferably less than 0.1% by weight, of alkyd resins, acrylic resins, melamine resins and/or melamine-phenol-formaldehyde resins, especially melamine resins, based on the total weight of the epoxy resin composition.

In the present document, the term “alkyd resin”, “acrylic resin”, “melamine resin” and “melamine-phenol-formaldehyde resin” are understood to mean compositions as described in Römpp Chemie Lexikon, online version, Georg Thieme Verlag, retrieved on Jun. 17, 2018.

It may further be advantageous when the thermosetting epoxy resin compositions of the invention include less than 5% by weight, especially less than 1% by weight, preferably less than 0.5% by weight, more preferably less than 0.3% by weight, less than 0.1% by weight, most preferably less than 0.05% by weight, of accelerators for epoxy resins, selected from the list consisting of substituted ureas, imidazoles, imidazolines and amine complexes, especially substituted ureas, based on the total weight of the epoxy resin composition.

Such accelerating curing agents are, for example, substituted ureas, for example 3-(3-chloro-4-methylphenyl)-1,1-dimethylurea (chlortoluron) or phenyldimethylureas, in particular p-chlorophenyl-N,N-dimethylurea (monuron), 3-phenyl-1,1-dimethylurea (fenuron) or 3,4-dichlorophenyl-N,N-dimethylurea (diuron). Also possible are compounds from the class of the imidazoles, such as 2-isopropylimidazole or 2-hydroxy-N-(2-(2-(2-hydroxyphenyl)-4,5-dihydroimidazol-1-yl)ethyl)benzamide, imidazolines and amine complexes.

0.8 or 0.2 part by weight of a substituted urea was additionally added to compounds according to the composition in examples part Z3, Z4 or Z5. However, this led, in the 1st cure, to such high gas formation in the composition that measurement of the adhesive bond was no longer possible.

It may further be advantageous when the thermosetting epoxy resin compositions of the invention include less than 5% by weight, especially less than 1% by weight, preferably less than 0.5% by weight, more preferably less than 0.3% by weight, most preferably less than 0.1% by weight, of curing agents for epoxy resins, selected from the list consisting of anhydrides of polybasic carboxylic acids and dihydrazides, based on the total weight of the epoxy resin composition.

The one-component thermosetting epoxy resin composition comprises at least one toughness improver D. The toughness improvers D may be liquid or solid.

The toughness improver D is a terminally blocked polyurethane polymer D1, especially a terminally blocked polyurethane polymer of the formula (I).

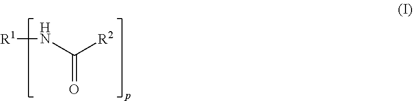

R¹ here is a p-valent radical of a linear or branched polyurethane prepolymer terminated by isocyanate groups after the removal of the terminal isocyanate groups, and p has a value of 2 to 8.
Moreover, R² is a blocking group which is eliminated at a temperature exceeding 100° C.
Preferably, R² is independently a substituent selected from the group consisting of

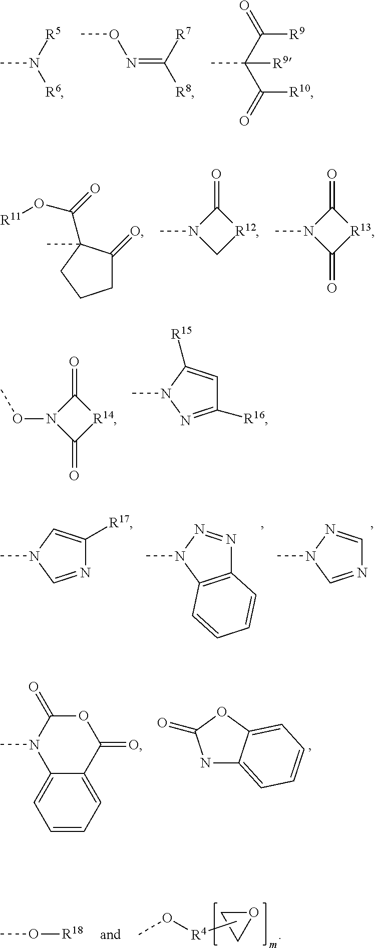

R⁵, R⁶, R⁷ and R here are each independently an alkyl or cycloalkyl or aralkyl or arylalkyl group, or R⁵ together with R⁶, or R⁷ together with R⁸, form part of a 4- to 7-membered, optionally substituted ring.

In addition, R^{9′} and R¹⁰ are each independently an alkyl or aralkyl or arylalkyl group or an alkyloxy or aryloxy or aralkyloxy group, and R¹¹ is an alkyl group.

R¹², R¹³ and R¹⁴ are each independently an alkylene group which has 2 to 5 carbon atoms and optionally has double bonds or is substituted, or a phenylene group or a hydrogenated phenylene group.

R¹⁵, R¹⁶ and R¹⁷ are each independently H or an alkyl group or an aryl group or an aralkyl group, and R¹⁸ is an aralkyl group or a mono- or polycyclic, substituted or unsubstituted aromatic group that optionally has aromatic hydroxyl groups.

Finally, R⁴ is a radical of an aliphatic, cycloaliphatic, aromatic or araliphatic epoxide containing a primary or secondary hydroxyl group after the removal of the hydroxyl and epoxy groups, and m has a value of 1, 2 or 3.

More preferably, R² is independently a substituent selected from the group consisting of

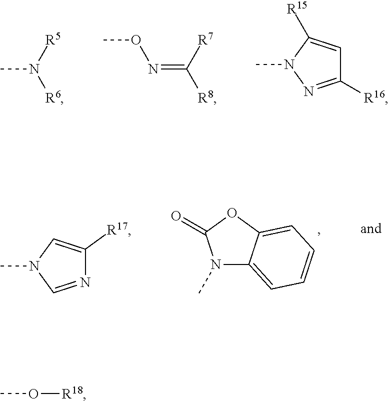

especially

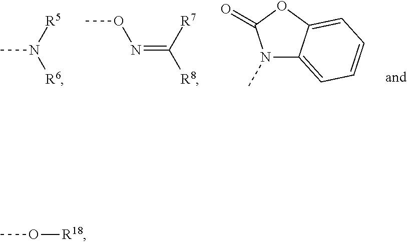

preferably

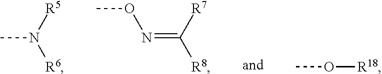

more preferably

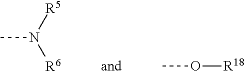

most preferably
- - - O—R¹⁸.

R¹⁸ is considered to be especially phenols after removal of a hydroxyl group. Preferred examples of such phenols are especially selected from the list consisting of phenol, cresol, 4-methoxyphenol (HQMME), resorcinol, catechol, cardanol (3-pentadecenylphenol (from cashew nut shell oil)) and nonylphenol.

R¹⁸ is secondly considered to be especially hydroxybenzyl alcohol and benzyl alcohol after removal of a hydroxyl group.

Preferred substituents of the formula - - - O—R¹⁸ are monophenols after removal of a phenolic hydrogen atom. Particularly preferred examples of such R² radicals are radicals selected from the group consisting of

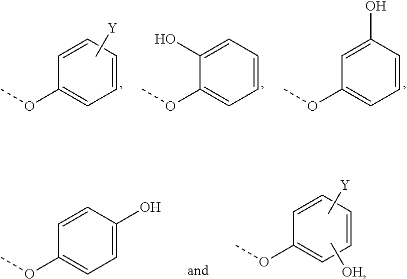

preferably

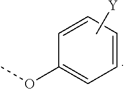

The Y radical here is a saturated, aromatic or olefinically unsaturated hydrocarbyl radical having 1 to 20 carbon atoms, especially having 1 to 15 carbon atoms. Preferred Y are especially allyl, methyl, nonyl, dodecyl, phenyl, alkyl ether, especially methyl ether, carboxylic ester or an unsaturated C₁₅-alkyl radical having 1 to 3 double bonds. Most preferably, Y is selected from the group consisting of alkyl ether, especially methyl ether, and unsaturated C₁₅-alkyl radical having 1 to 3 double bonds.

More preferably, R¹⁸ comprises phenols after removal of one hydroxyl group; particularly preferred examples of such phenols are selected from the list consisting of 4-methoxyphenol (HQMME) and cardanol (3-pentadecenylphenol (from cashew nut shell oil)).

The terminally blocked polyurethane prepolymer of the formula (I) is prepared from the linear or branched polyurethane prepolymer terminated by isocyanate groups with one or more isocyanate-reactive compounds R²H. If two or more such isocyanate-reactive compounds are used, the reaction can be effected sequentially or with a mixture of these compounds.

The polyurethane prepolymer with isocyanate end groups on which R¹ is based can be prepared in particular from at least one diisocyanate or triisocyanate and from a polymer Q_{PM} having terminal amino, thiol or hydroxyl groups.

Suitable diisocyanates are aliphatic, cycloaliphatic, aromatic or araliphatic diisocyanates, especially commercial products such as methylene diphenyl diisocyanate (MDI), hexamethylene diisocyanate (HDI), toluene diisocyanate (TDI), toluidine diisocyanate (TODI), isophorone diisocyanate (IPDI), trimethylhexamethylene diisocyanate (TMDI), 2,5- or 2,6-bis(isocyanatomethyl)bicyclo[2.2.1]heptane, naphthalene 1,5-diisocyanate (NDI), dicyclohexylmethyl diisocyanate (H₁₂MDI), p-phenylene diisocyanate (PPDI), m-tetramethylxylylene diisocyanate (TMXDI), etc. and dimers thereof. Preference is given to HDI, IPDI, MDI or TDI.

Suitable triisocyanates are trimers or biurets of aliphatic, cycloaliphatic, aromatic or araliphatic diisocyanates, especially the isocyanurates and biurets of the diisocyanates described in the previous paragraph. It is of course also possible to use suitable mixtures of di- or triisocyanates.

Especially suitable polymers Q_{PM} having terminal amino, thiol or hydroxyl groups are polymers Q_{PM} having two or three terminal amino, thiol or hydroxyl groups.

The polymers Q_{PM} advantageously have an equivalent weight of 300-6000, especially of 600-4000, preferably of 700-2200, g/equivalent of NCO-reactive groups.

Preferred polymers Q_{PM} are polyols having average molecular weights between 600 and 6000 daltons, selected from the group consisting of polyethylene glycols, polypropylene glycols, polyethylene glycol-polypropylene glycol block polymers, polybutylene glycols, polytetramethylene ether glycols, hydroxyl-terminated polybutadienes, hydroxyl-terminated butadiene-acrylonitrile copolymers and mixtures thereof; polytetramethylene ether glycols and hydroxyl-terminated polybutadienes are especially preferred.

It is possible to use one or more polytetramethylene ether glycols. Polytetramethylene ether glycol is also referred to as polytetrahydrofuran or PTMEG. PTMEG can be prepared, for example, by polymerization of tetrahydrofuran, for example via acidic catalysis. The polytetramethylene ether glycols are especially diols.
Polytetramethylene ether glycols are commercially available, for example the PolyTHF® products from BASF such as PolyTHF®2000, PolyTHF®2500 CO or PolyTHF3000 CO, the Terathane® products from Invista B.V or the Polymeg® products from LyondellBasell.
The OH functionality of the polytetramethylene ether glycol used is preferably in the region of about 2, for example in the range from 1.9 to 2.1. This results from the cationic polymerization of the starting tetrahydrofuran monomer.
Advantageous polytetramethylene ether glycols are those having OH numbers between 170 mg/KOH g and 35 mg KOH/g, preferably in the range from 100 mg KOH/g to 40 mg KOH/g, and most preferably 70 to 50 mg KOH/g. Unless stated otherwise, in the present application, the OH number is determined by titrimetry to DIN 53240. The hydroxyl number is determined here by acetylation with acetic anhydride and subsequent titration of the excess acetic anhydride with alcoholic potassium hydroxide solution.
With knowledge of the difunctionality, it is possible to use the hydroxyl numbers ascertained by titrimetry to ascertain the OH equivalent weights or average molecular weight of the polytetramethylene ether glycol used.
Polytetramethylene ether glycols used advantageously in the present invention preferably have an average molecular weight in the range from 600 to 5000 g/mol, more preferably 1000 to 3000 g/mol and especially preferably in the range from 1500 to 2500 g/mol, especially about 2000 g/mol.
It is possible to use one or more hydroxyl-terminated polybutadiene(s). It is also possible to use mixtures of two or more hydroxyl-terminated polybutadienes.
Suitable hydroxyl-terminated polybutadienes are especially those that are prepared by free-radical polymerization of 1,3-butadiene, using, for example, an azo nitrile or hydrogen peroxide as initiator. Hydroxyl-terminated polybutadienes are commercially available, for example the Poly bd® products from Cray Valley such as Poly bd R45V, Polyvest®HT from Evonik, and Hypro®2800X95HTB from Emerald Performance Materials LLC.
The hydroxyl-terminated polybutadiene preferably has an average molecular weight of less than 5000, preferably in the range from 2000 to 4000, g/mol. The OH functionality of the hydroxyl-terminated polybutadiene is preferably in the range from 1.7 to 2.8, preferably from 2.4 to 2.8.
Further preferred are hydroxyl-terminated polybutadienes having an acrylonitrile content of less than 15%, preferably less than 5%, especially preferably less than 1%, especially preferably of less than 0.1%. Most preferred are hydroxyl-terminated polybutadienes free of acrylonitrile.
Based on the total weight of the polyols used for preparation of the isocyanate-terminated polymer, the total proportion of polytetramethylene ether glycol and hydroxyl-terminated polybutadiene is preferably at least 95% by weight and more preferably at least 98% by weight. In a preferred embodiment, solely polytetramethylene ether glycol and/or hydroxyl-terminated polybutadiene are used as polyols.
The weight ratio of polytetramethylene ether glycol to hydroxyl-terminated polybutadiene is preferably in the range from 100/0 to 70/30, more preferably from 100/0 to 60/40, more preferably from 100/0 to 90/10 and most preferably 100/0.

In a preferred embodiment, the polyurethane prepolymer is prepared from at least one diisocyanate or triisocyanate and from a polymer Q_{PM} having terminal amino, thiol or hydroxyl groups. The polyurethane prepolymer is prepared in a manner known to the person skilled in the art of polyurethane, especially by using the diisocyanate or triisocyanate in a stoichiometric excess in relation to the amino, thiol or hydroxyl groups of the polymer Q_{PM}.

The polyurethane prepolymer having isocyanate end groups preferably has elastic character. It preferably exhibits a glass transition temperature Tg of less than 0° C.

The weight ratio of the at least one epoxy resin A having an average of more than one epoxy group per molecule to the at least one toughness improver D is 0.4-3.3.

A weight ratio of less than 0.4 is disadvantageous in that the compositions cure very slowly, if at all, as a result. Further, low values in particular are obtained in modulus of elasticity, tensile strength and angular peel strength.

A weight ratio of more than 3.3 is disadvantageous in that the compositions having low values of elongation at break are obtained as a result.

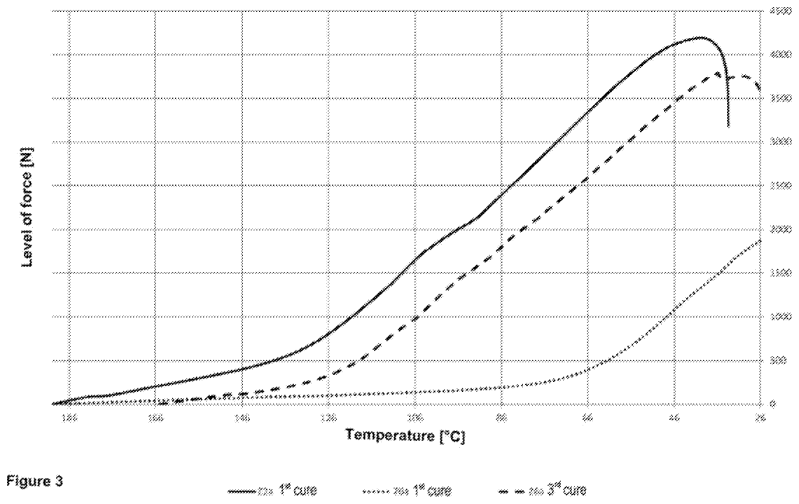

The weight ratio is preferably less than 2.8, especially less than 2.4, more preferably less than 2.0, resulting in an improvement in delta-alpha resistance; in particular, lower values for the level of force are obtained. This is apparent in FIG. 3. While adhesive failure already occurs in the first cure in the case of Z2a, slight weakening of the adhesive bond is only apparent in the 3rd cure the the Z6a.

Preferably, the weight ratio of the at least one epoxy resin A having an average of more than one epoxy group per molecule to the at least one toughness improver D is 0.55-2.4, more preferably 0.7-2.0, 1.0-1.8, most preferably 1.0-1.6. This is advantageous in that the compositions have high values for modulus of elasticity and tensile strength after the third cure as a result. Moreover, low values are simultaneously obtained for the level of force, especially after the first cure.

In a further preferred embodiment, the composition additionally comprises at least one filler F. Preference is given here to mica, talc, kaolin, wollastonite, feldspar, syenite, chlorite, bentonite, montmorillonite, calcium carbonate (precipitated or ground), dolomite, quartz, silicas (fused or precipitated), cristobalite, calcium oxide, aluminum hydroxide, magnesium oxide, hollow ceramic beads, hollow glass beads, hollow organic beads, glass beads, color pigments.

Advantageously, the total proportion of the overall filler F is 5-40% by weight, preferably 10-30% by weight, based on the total weight of the epoxy resin composition.

In a further preferred embodiment, the composition additionally comprises at least one epoxy-bearing reactive diluent G. Such reactive diluents are known to the person skilled in the art. Preferred examples of epoxy-bearing reactive diluents are:
glycidyl ethers of monofunctional, saturated or unsaturated, branched or unbranched, cyclic or open-chain, C₄-C₃₀ alcohols, e.g. butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether, and the like;
glycidyl ethers of difunctional, saturated or unsaturated, branched or unbranched, cyclic or open-chain, C₂-C₃₀ alcohols, e.g. ethylene glycol glycidyl ether, butanediol glycidyl ether, hexanediol glycidyl ether, octanediol glycidyl ether, cyclohexanedimethanol diglycidyl ether, neopentyl glycol diglycidyl ether, and the like;
glycidyl ethers of tri- or polyfunctional, saturated or unsaturated, branched or unbranched, cyclic or open-chain, alcohols, such as epoxidized castor oil, epoxidized trimethylolpropane, epoxidized pentaerythritol or polyglycidyl ethers of aliphatic polyols, such as sorbitol, glycerol, trimethylolpropane, and the like;
glycidyl ethers of phenol compounds and aniline compounds, such as phenyl glycidyl ether, cresyl glycidyl ether, p-tert-butylphenyl glycidyl ether, nonylphenol glycidyl ether, 3-n-pentadecenyl glycidyl ether (from cashew nut shell oil), N,N-diglycidylaniline, and the like;
epoxidized amines, such as N,N-diglycidylcyclohexylamine, and the like;
epoxidized mono- or dicarboxylic acids, such as glycidyl neodecanoate, glycidyl methacrylate, glycidyl benzoate, diglycidyl phthalate, tetrahydrophthalate and hexahydrophthalate, diglycidyl esters of dimeric fatty acids, and the like;
epoxidized di- or trifunctional, low to high molecular weight polyether polyols, such as polyethylene glycol diglycidyl ether, polypropylene glycol diglycidyl ether, and the like.

Particular preference is given to hexanediol diglycidyl ether, cresyl glycidyl ether, p-tert-butylphenyl glycidyl ether, polypropylene glycol diglycidyl ether and polyethylene glycol diglycidyl ether.

Advantageously, the total proportion of the epoxy-bearing reactive diluent G is 0.1-15% by weight, preferably 0.1-5% by weight, especially preferably 0.1-2% by weight, more preferably 0.2-1% by weight, based on the total weight of the epoxy resin composition.

The composition may include further constituents, especially catalysts, stabilizers, especially heat and/or light stabilizers, thixotropic agents, plasticizers, solvents, mineral or organic fillers, blowing agents, dyes and pigments, anticorrosives, surfactants, defoamers and adhesion promoters.

Suitable plasticizers are especially phenol alkylsulfonates or N-butylbenzamide, as commercially available as Mesamoll® or Dellatol BBS from Bayer.

Suitable stabilizers are especially optionally substituted phenols such as BHT or Wingstay® T (Elikem), sterically hindered amines or N-oxyl compounds such as TEMPO (Evonik).

A particularly preferred one-component epoxy resin composition comprises:
10-70% by weight, especially 30-60% by weight, based on the total weight of the epoxy resin composition, of epoxy resin A having an average of more than one epoxy group per molecule; preferably 60-85% by weight, 60-80% by weight, especially 65-80% by weight, more preferably 70-80% by weight, of the epoxy resin A is a liquid epoxy resin and 15-40% by weight, 20-40% by weight, 20-35% by weight, especially 20-30% by weight, of the epoxy resin A is a solid epoxy resin;
at least one 2,4-diamino-1,3,5-triazine GU, preferably selected from the list consisting of 6-nonyl-2,4-diamino-1,3,5-triazine (caprinoguanamine), 6-phenyl-2,4-diamino-1,3,5-triazine (benzoguanamine) and 6-methyl-2,4-diamino-1,3,5-triazine (acetoguanamine); especially 6-phenyl-2,4-diamino-1,3,5-triazine (benzoguanamine) and 6-methyl-2,4-diamino-1,3,5-triazine (acetoguanamine); most preferably 6-methyl-2,4-diamino-1,3,5-triazine (acetoguanamine);
at least one toughness improver D, preference being given to those that have been described above as preferred toughness improvers D; the amount of toughness improvers D is preferably 20-60% by weight, 25-55% by weight, 30-50% by weight, more preferably 30-45% by weight, based on the total weight of the epoxy resin composition;
preferably 5-40% by weight, preferably 10-30% by weight, based on the total weight of the epoxy resin composition, of a filler F, preferably selected from the group consisting of wollastonite, calcium carbonate, calcium oxide, color pigments, especially carbon black, and fumed silicas, especially calcium carbonate, calcium oxide and fumed silicas;
preferably 0.1-15% by weight, preferably 0.1-5% by weight, especially preferably 0.1-2% by weight, more preferably 0.2-1% by weight, based on the total weight of the epoxy resin composition, of an epoxy-bearing reactive diluent G;
where
   the weight ratio of the at least one epoxy resin A having an average of more than one epoxy group per molecule to the at least one toughness improver D is 0.55-2.4, more preferably 0.7-2.0, 1.0-1.8, most preferably 1.0-1.6, especially preferably 1.0-1.6.

It may further be advantageous when the preferred one-component epoxy resin composition consists of the aforementioned constituents to an extent of more than 80% by weight, preferably more than 90% by weight, especially more than 95% by weight, especially preferably more than 98% by weight, most preferably more than 99% by weight, based on the total weight of the epoxy resin composition.

It is advantageous when the epoxy resin composition of the invention has a viscosity at 25° C. of 100-10 000 Pa*s, especially 500-5000 Pa*s, preferably 1000-3000 Pa*s. This is advantageous in that this assures good applicability. Viscosity is preferably measured on an Anton Paar MCR 101 rheometer by oscillation using a plate-plate geometry at a temperature of 25° C. with the following parameters: 5 Hz, 1 mm gap, plate-plate distance 25 mm, 1% deformation.

Particular preference is given to thermosetting epoxy resin compositions having, in the cured state:
a lap shear strength, especially measured to DIN EN 1465, more preferably as described in the examples, of more than 10 MPa, more than MPa, more than 20 MPa, and/or
a tensile strength, especially measured to DIN EN ISO 527, more preferably as described in the examples, of more than 10 MPa, more than MPa, more than 20 MPa, and/or
an elongation at break, especially measured to DIN EN ISO 527, more preferably as described in the examples, of more than 10%, more than 15%, more than 20%, especially 20-200%, more preferably 30-150%, and/or
a modulus of elasticity, especially measured to DIN EN ISO 527, more preferably as described in the examples, of 800-1500 MPa, especially of 500-1200 MPa, and/or
an impact peel strength, especially measured to ISO 11343, more preferably as described in the examples, of more than 30 N/mm, more than 40 N/mm, more than 50 N/mm, at 23° C., and/or
an impact peel strength, especially measured to ISO 11343, more preferably as described in the examples, of more than 25 N/mm, more than 30 N/mm, more than 40 N/mm, more than 50 N/mm, at −30° C., and/or
an angular peel strength, especially measured to DIN 53281, more preferably as described in the examples, of more than 5 N/mm, more than 8 N/mm, more than 10 N/mm.

It has been found that the thermosetting epoxy resin compositions described are particularly suitable for use as one-component thermosetting adhesives, especially as thermosetting one-component adhesive in vehicle construction and sandwich panel construction. Such a one-component adhesive has a range of possible uses. More particularly, thermosetting one-component adhesives that feature high impact resistance, both at higher temperatures and at low temperatures, are achievable thereby. Such adhesives are required for the adhesive bonding of heat-stable materials. Heat-stable materials are understood to mean materials that are dimensionally stable at least during the curing time at a curing temperature of 100-220° C., preferably 120-200° C. More particularly, these are metals and plastics such as ABS, polyamide, epoxy resin, polyester resin, polyphenylene ether, fiber-reinforced plastics such as glass fiber- and carbon fiber-reinforced plastics. Particularly preferred plastics are fiber-reinforced plastics. Preference is given to the use in which at least one material is a metal. A particularly preferred use is considered to be the bonding of different metals, especially metals, having different linear thermal coefficients of expansion (Δα) and/or the bonding of metals to fiber-reinforced plastics, especially in bodyshell construction in the automotive industry. The preferred metals are in particular steel, especially electrolytically galvanized, hot-dip-galvanized or oiled steel, Bonazinc-coated steel, and post-phosphated steel, and also aluminum, especially in the variants which typically occur in automobile construction.

Such an adhesive is especially contacted first with the materials to be bonded at a temperature of between 10° C. and 80° C., especially between 10° C. and 60° C., and later cured at a temperature of typically 100-220° C., preferably 140-200° C.

A further aspect of the present invention therefore relates to a use of a thermosetting epoxy resin composition as described above as one-component thermosetting adhesive, especially as thermosetting one-component adhesive in vehicle construction and sandwich panel construction, especially in vehicle construction.

Such an aforementioned use results in a bonded article. Such an article is preferably a vehicle or part of a vehicle.

A further aspect of the present invention accordingly relates to an adhesive-bonded article obtained from the abovementioned use. It is of course possible to use a composition of the invention to realize not only thermosetting adhesives but also sealing compounds. Furthermore, the compositions according to the invention are suitable not only for automobile construction but also for other fields of use. Particular mention should be made of related applications in the construction of transportation means, such as ships, trucks, buses or rail vehicles, or in the construction of consumer goods, such as, for example, washing machines.

The materials adhesive-bonded by means of an aforementioned composition are used at temperatures between typically 120° C. and −40° C., preferably between 100° C. and −40° C., in particular between 80° C. and −40° C.

A further aspect of the present invention relates to a process for the bonding of heat-stable substrates, which comprises the stages:
a) applying a thermosetting epoxy resin composition as described above to the surface of a heat-stable substrate S1, especially of a metal;
b) contacting the thermosetting epoxy resin composition applied with the surface of a further heat-stable substrate S2, especially of a metal;
c) heating the epoxy resin composition to a temperature of 100 to 220° C., preferably 140-220° C., especially 140-200° C., preferably between 160 and 190° C.;
d) cooling the epoxy resin composition to a temperature of less than 50° C., preferably 50-10° C., especially of 40-15° C.;
e) reheating the epoxy resin composition to a temperature of 100 to 220° C., preferably 100-200° C., especially of 100-170° C., preferably between 120 and 170° C.;
f) preferably recooling the epoxy resin composition to a temperature of less than 50° C., preferably 50-10° C., especially of 40-15° C.;
g) preferably reheating the epoxy resin composition to a temperature of 100 to 220° C., preferably 100-200° C., especially of 100-170° C., preferably between 120 and 170° C.

Heat-stable materials S1 and S2 are understood to mean materials that are dimensionally stable at least during the curing time at a curing temperature of 100-220° C., preferably 120-200° C. More particularly, these are metals and plastics such as ABS, polyamide, epoxy resin, polyester resin, polyphenylene ether, fiber-reinforced plastics such as glass fiber- and carbon fiber-reinforced plastics. Particularly preferred plastics are fiber-reinforced plastics. At least one material is preferably a metal.

A particularly preferred method is considered to be the bonding of heat-stable substrates, especially metals, having different linear thermal coefficients of expansion (Δα) and/or the bonding of metals to fiber-reinforced plastics, especially in bodyshell construction in the automotive industry. The preferred metals are in particular steel, especially electrolytically galvanized, hot-dip-galvanized or oiled steel, Bonazinc-coated steel, and post-phosphated steel, and also aluminum, especially in the variants which typically occur in automobile construction.

More preferably, the difference in the coefficient of linear thermal expansion (Δα) between the heat-stable material S1 and the heat-stable material S2 is 10-25*10⁻⁶ [K⁻¹], especially 10-15*10⁻⁶ [K⁻¹].

It is advantageous when, in step c) and in step e) and optionally and preferably in step g), heating the epoxy resin composition, the epoxy resin composition is left at the aforementioned temperature, especially the temperature identified as preferred, for 20 min-60 min, 25 min-55 min, 30 min-50 min, more preferably 30 min-40 min.

Preferably, in steps c) and e) and optionally f), the epoxy resin composition is heated in an oven.

It is advantageous when, in step d) and preferably in step f), the epoxy resin composition is cooled to a temperature of less than 50° C., preferably 50-10° C., especially of 40-15° C., the epoxy resin composition is left at the aforementioned temperature for more than 5 min, more than 10 min, more than 20 min, more than 25 min, especially preferably 30-60 min.

A local transport step, for example transport to another oven, preferably takes place between steps c) and e) and optionally between steps e) and g) with the composite of the epoxy resin composition with the heat-stable substrates S1 and S2.

It is also further advantageous for there to be a period of time between steps c) and e) and optionally between steps e) and g) of more than 5 min, more than 10 min, more than 20 min, more than 25 min, particularly preferably 30-120 min, most preferably 30-60 min.

Furthermore, there is preferably a time gap, between stages a) and c), of less than 12 h, less than 3 h, particularly preferably 30-120 min.

### EXAMPLES

Some examples which further illustrate the invention, but which are not intended to restrict the scope of the invention in any way, are cited below.

### Determination of Isocyanate Content

The isocyanate content was determined in % by weight by means of a back-titration with di-n-butylamine used in excess and 0.1 M hydrochloric acid. All determinations were conducted in a semi-manual manner on a Mettler-Toledo DL50 Graphix titrator with automatic potentiometric endpoint determination. For this purpose, 600-800 mg in each case of the sample to be determined was dissolved while heating in a mixture of 10 ml of isopropanol and 40 ml of xylene, and then reacted with a solution of dibutylamine in xylene. Excess di-n-butylamine was titrated with 0.1 M hydrochloric acid, and the isocyanate content was calculated therefrom.

### Level of Force

The level of force was determined as described above under “Description of test method for the level of force”. A triple determination was conducted for each epoxy resin composition. The level of force is the force measured at the end of the cooling phase at 25° C., i.e. on attainment of a longitudinal expansion of 2.145 mm for the 1st cure or 1.820 mm for the 3rd cure.

### Tensile Strength (ZF), Elonqation at Break (BD) and Modulus of Elasticity (DIN EN ISO 527)

An adhesive sample was pressed between two Teflon papers to a layer thickness of 2 mm. After curing at 175° C. for 35 min, the Teflon papers were removed and the specimens were die-cut to the DIN standard state. The test specimens were examined under standard climatic conditions at a strain rate of 2 mm/min. Tensile strength, elongation at break and the 0.05-0.25% modulus of elasticity were measured to DIN EN ISO 527.

### Tensile Shear Strength (ZSF) (DIN EN 1465)

Cleaned test specimens of H420+Z steel (thickness 1.2 mm) that had been reoiled with Anticorit PL 3802-39S were bonded with the adhesive over a bonding area of 25×10 mm with glass beads as spacer in a layer thickness of 1.5 mm, and cured under the curing conditions specified.

Curing conditions: a) 35 min at oven temperature 175° C.

Lap shear strength was determined on a tensile tester at a strain rate of 10 mm/min in a triple determination to DIN EN 1465.

### T-Peel Strength (DIN 53281)

130×25 mm test sheets of DC-04+ZE steel (thickness 0.8 mm) were prepared. Test sheets were processed at a height of 30 mm with a suitable die-cutting machine (90°). The cleaned 100×25 mm surfaces that had been reoiled with Anticorit PL 3802-39S were bonded with the adhesive with glass beads as spacer in a layer thickness of 0.3 mm, and cured for a dwell time of 35 min from attainment of oven temperature 175° C. T-peel strength was determined on a tensile testing machine at a strain rate of 100 mm/min in a duplicate determination as peel force in N/mm in the traversed distance range from ⅙ to ⅚ of the distance covered.

### Impact Peel Strength (IP) (to ISO 11343)

The specimens were produced with the adhesive and DC04+ZE steel with dimensions of 90×20×0.8 mm. The bonding area here was 20×30 mm at a layer thickness of 0.3 mm with glass beads as spacer. Impact peel strength was measured in each case at the temperatures specified (23° C., −30° C.) as a triple determination on a Zwick 450 impact pendulum at 2 m/s. The impact peel strength reported is the average force in N/mm under the measurement curve from 25% to 90% to ISO11343.

The adhesives were cured at oven temperature 175° C. for 35 min.

The following commercial products were used for the production of the impact modifier SM:

TABLE 1

| Compound | Description | Manufacturer |
|---|---|---|
| BHT (Ionol ® CP) | Butylhydroxytoluene | Evonik |
| | stabilizer | |
| PolyTHF ® 2000 | Difunctional | BASF |
| | polytetramethylene | |
| | ether glycol having a | |
| | molar mass of 2000 g/mol | |
| Poly bd ® R45V | Hydroxyl-terminated | Cray Valley |
| | polybutadiene having a | |
| | molar mass of 2800 g/mol, | |
| | OH functionality | |
| | about 2.4-2.6 | |
| Vestanat IPDI | Isophorone diisocyanate | Evonik |
| Dibutyltin dilaurate | Catalyst | Thorson |
| 4-Methoxyphenol | Blocking agent | Solvay |

200 g of PolyTHF 2000, 200 g of Poly bd R45V and 2.00 g BHT as stabilizer were dewatered at 90° C. under reduced pressure with minimal stirring for 1 h. Subsequently, 80.64 g of isophorone diisocyanate (IPDI) and 0.053 g of dibutyltin dilaurate (DBTDL) were added. The reaction was conducted under moderate stirring at 90° C. under reduced pressure for 2 h in order to obtain an isocyanate-terminated polymer: Measured free NCO content: 2.81%.

To the resultant NCO-terminated polymer were added 0.106 g of dibutyltin dilaurate (DBTDL) and 47.93 g of 4-methoxyphenol (HQMME), and the isocyanate groups were depleted by reaction at 110° C. under reduced pressure for 5 h. Measured free NCO content: (directly after preparation) 2.82%, (1 day after preparation) 0.09%.

### Adhesive Compositions Z1 to Z11, Z2a/Z6a and Z2b/Z6b/Z7b

The impact modifier SM was used in each case for production of epoxy resin compositions according to table 2. The proportions of the compounds present in the epoxy resin compositions are displayed in parts by weight in table 2.

TABLE 2

| Z1-Z11 | Z2a, Z6a | Z2b, Z6b, Z7b | | |
|---|---|---|---|---|
| Parts by | Parts by | Parts by | | |
| weight | weight | weight | Chemical composition | Function |
| 38 | 53 | 33 | Epoxy resin based on | Epoxy resin matrix |
| | | | bisphenol A, liquid | |
| 12 | 12 | 12 | Epoxy resin based on | Epoxy resin matrix |
| | | | bisphenol A, solid | |
| 0.5 | 0.5 | 0.5 | p-tert-Butylphenyl | Reactive diluent |
| | | | glycidyl ether | |
| 35 | 20 | 40 | Blocked polyurethane, SM-X | Impact modifier |
| * | * | * | Dicyandiamide | Curing agent |
| * | * | * | Benzoguanamine | Curing agent |
| * | * | * | Acetoguanamine | Curing agent |
| * | * | * | Caprinoguanamine | Curing agent |
| ** | — | — | Substituted urea | Accelerator |
| 5.0 | 5.0 | 5.0 | CaCO₃ | Filler |
| 6.0 | 6.0 | 6.0 | Calcium oxide | Moisture scavenger |
| 8.0 | 8.0 | 8.0 | Fumed silica | Thixotropic agent |
| 0.3 | 0.3 | 0.3 | Carbon black | Coloring |

* according to table 3,
** only Z1 additionally includes 0.8 part by weight of a substituted urea

The respective epoxy resin compositions were mixed in a planetary mixer in a batch size of 350 g. For this purpose, the mixing vessel was filled with the liquid components, followed by the solid components, and they were mixed at 70° C. under reduced pressure. During the mixing operation (about 45 min), the vacuum was broken several times and the mixing tool wiped clean. After a homogeneous mixture had been obtained, the epoxy resin composition was dispensed into cartridges and stored at room temperature.

Table 3 shows the amount of 2,4-diamino-1,3,5-triazine GU, or dicyandiamide (Dicy), additionally added to the epoxy resin compositions in table 2, in parts by weight.

“Curing agent/EP” describes the ratio of the total amount of 2,4-diamino-1,3,5-triazine GU plus, if appropriate, the total amount of dicyandiamide to the total amount of epoxy groups in the epoxy resin A for a stoichiometric curing necessary ratio, in %. 100% corresponds to stoichiometric curing. For this purpose, a curing agent functionality of 4 is assumed for 2,4-diamino-1,3,5-triazine GU, and a curing agent functionality of 5.5 for dicyandiamide.

“GU/Dicy” denotes the molar ratio of 2,4-diamino-1,3,5-triazine GU to dicyandiamide.

“A/D” describes the weight ratio of the at least one epoxy resin A having an average of more than one epoxy group per molecule to the at least one toughness improver D.

Table 4 shows the results of the evaluation of the epoxy resin compositions obtained.

The measurements under “Adhesive properties after 1st cure 35 min/175° C.” were obtained by means of test specimens that were produced by means of the step of “Simulation of the cure state after cathodic electrocoating oven” 4A.) (1st cure), as described above under “Test specimens used and preparation thereof” in “Preparation”.

The measurements under “Adhesive properties after 1st cure 35 min/175° C.+2nd cure 35 min/160° C.+3rd cure 35 min/165° C.” were obtained by means of test specimens that were produced by means of the step of “Simulation of the cure state after passing through all process ovens” 4B.) (3rd cure), as described above under “Test specimens used and preparation thereof” in “Preparation”.

“Blisters” refers to the isolated occurrence of blisters owing to evolution of gas during curing in the fracture profile of the cured test specimens. These are disadvantageous in that their resultant defects (cavities) can have an adverse effect on mechanical properties.

FIGS. 1 to 4 show the evolution of the level of force during step 5.) Cooling of the samples after the simulation of the cure state 4A.) (1st cure), or 4B.) (3rd cure), as described above under “Test specimens used and preparation thereof” in “Preparation”.

TABLE 3

| | Z1 | Z2 | Z3 | Z4 | Z5 | Z6 | Z7 | Z8 | Z9 | Z10 | Z11 | Z2a | Z6a | Z2b | Z6b | Z7b |
|---|---|---|---|---|---|---|---|---|---|---|---|---|---|---|---|---|
| Dicy | 3.57 | 3.57 | — | — | — | 0.71 | 1.07 | 0.71 | 1.07 | 0.71 | 1.07 | 4.81 | 0.96 | 3.16 | 0.63 | 0.95 |
| Benzo- | — | — | 10.94 | — | — | 8.75 | 7.66 | — | — | — | — | — | 11.79 | — | 7.74 | 6.77 |
| guanamine | | | | | | | | | | | | | | | | |
| Aceto- | — | — | — | 7.31 | — | — | — | 5.85 | 5.12 | — | — | — | — | — | — | — |
| guanamine | | | | | | | | | | | | | | | | |
| Caprino- | — | — | — | — | 13.87 | — | — | — | — | 11.10 | 9.71 | — | — | — | — | — |
| guanamine | | | | | | | | | | | | | | | | |
| Curing | 100% | 100% | 100% | 100% | 100% | 100% | 100% | 100% | 100% | 100% | 100% | 100% | 100% | 100% | 100% | 100% |
| agent/EP | | | | | | | | | | | | | | | | |
| GU/Dicy | — | — | — | — | — | 12.3 | 7.2 | — | — | — | — | — | 12.3 | — | 12.3 | 7.1 |
| A/D | 1.43 | 1.43 | 1.43 | 1.43 | 1.43 | 1.43 | 1.43 | 1.43 | 1.43 | 1.43 | 1.43 | 3.25 | 3.25 | 1.13 | 1.13 | 1.13 |

TABLE 4

| | | | | | | | | | | | | | | | |
|---|---|---|---|---|---|---|---|---|---|---|---|---|---|---|---|
| Z1 | Z2 | Z3 | Z4 | Z5 | Z6 | Z7 | Z8 | Z9 | Z10 | Z11 | Z2a | Z6a | Z2b | Z6b | Z7b |

Adhesive properties after 1st cure 35 min/175° C.

| | | | | | | | | | | | | | | | | |
|---|---|---|---|---|---|---|---|---|---|---|---|---|---|---|---|---|
| Modulus of | 1070 | 1030 | 60 | 970 | 568 | 606 | 1000 | 1170 | 1110 | 929 | 943 | 1730 | 1680 | 842 | 384 | 619 |
| elasticity [MPa] | | | | | | | | | | | | | | | | |
| ZF [MPa] | 25 | 27 | 1.3 | 18 | 10 | 12 | 22 | 23 | 23 | 19 | 20 | 38.1 | 3 | 22.5 | 10 | 13 |
| BD [%] | 20 | 21 | 240 | 6 | 40 | 40 | 25 | 7 | 11 | 16 | 21 | 8.3 | 0.2 | 40.9 | 100 | 83 |
| ZSF [MPa] | 25.7 | 26.8 | 6.0 | 17.4 | 12.9 | 18.5 | 23.3 | 25.4 | 25.7 | 23.8 | 24.8 | 29.1 | 19.6 | 24.6 | 18 | 19.8 |
| IP 23° C. | 49.6 | 45.3 | 1.6 | 33.7 | 6.2 | 41 | 47 | 40.6 | 45.4 | 39 | 40.2 | 43.8 | 7 | 52.7 | 45.2 | 49.2 |
| IP −30° C. | 51.2 | 46.8 | 0.2 | 17.7 | 0.2 | 0 | 8.3 | 33.6 | 39.4 | 0 | 0 | 29.5 | 0.4 | 55.2 | 0 | 14.5 |
| T-peel | 11.1 | 12.2 | 2.0 | 5.7 | 3 | 11.1 | 11.9 | 10.7 | 10 | 6.2 | 6.1 | 7.3 | 3.3 | 12.8 | 11.6 | 12.3 |
| Blisters | − | − | + | + | + | − | − | + | − | + | − | − | − | − | − | − |

Adhesive properties after 1st cure 35 min/175° C. + 2nd cure 35 min/160° C. + 3rd cure 35 min/165° C.

| | | | | | | | | | | | | | | | | |
|---|---|---|---|---|---|---|---|---|---|---|---|---|---|---|---|---|
| Modulus of | 1060 | 1000 | 1060 | 1080 | 998 | 1070 | 1200 | 1150 | 1080 | 1030 | 1050 | 1750 | 2090 | 830 | 848 | 871 |
| elasticity [MPa] | | | | | | | | | | | | | | | | |
| ZF [MPa] | 26 | 27 | 22 | 22 | 21 | 22.7 | 26 | 23 | 23 | 22.4 | 23 | 39.3 | 42.2 | 23.2 | 19 | 20 |
| BD [%] | 25 | 21 | 7 | 6 | 13 | 15.5 | 19 | 9 | 9 | 9.1 | 15 | 7.6 | 6.5 | 47.7 | 28 | 31 |
| ZSF [MPa] | 24.8 | 27.6 | 19.6 | 24.4 | 19.7 | 26.4 | 25.7 | 26.3 | 26.3 | 24.9 | 23.8 | 30 | 29.7 | 26.6 | 23.5 | 23 |
| IP 23° C. | 52 | 46 | 36.4 | 37.5 | 31.6 | 47.6 | 49.4 | 43.7 | 45.5 | 39.7 | 47.3 | 46.6 | 33.3 | 54.3 | 47.4 | 50 |
| IP −30° C. | 53 | 48 | 13.4 | 30.6 | 2.9 | 41.1 | 43.4 | 37.9 | 42.8 | 10.8 | 38.5 | 31.7 | 3.8 | 59.2 | 45 | 45.3 |
| T-peel | 12.2 | 12.8 | 8.9 | 10 | 6.2 | 12.4 | 12.3 | 11.5 | 12 | 10.1 | 8.9 | 7.5 | 7.7 | 12.9 | 12.6 | 12.4 |

1. A one-component thermosetting epoxy resin composition comprising
a) at least one epoxy resin A having an average of more than one epoxy group per molecule;
b) at least one 2,4-diamino-1,3,5-triazine GU containing, in the 6 position,
an alkyl radical having 1 to 20 carbon atoms, in which one hydrogen atom in the α position has been replaced by a 2,4-diamino-1,3,5-triazin-6-yl radical,
a cycloalkyl radical having 5 to 12 carbon atoms or
an aryl radical having 6 to 12 carbon atoms;
c) at least one toughness improver D, which is a terminally blocked polyurethane polymer D1; and
wherein the weight ratio of the at least one epoxy resin A having an average of more than one epoxy group per molecule to the at least one toughness improver D is 0.4-3.3.

2. The one-component thermosetting epoxy resin composition as claimed in claim 1, wherein the terminally blocked polyurethane polymer D1 is a terminally blocked polyurethane prepolymer of the formula (I) 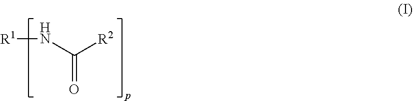
where R¹ is a p-valent radical of a linear or branched polyurethane prepolymer terminated by isocyanate groups after the removal of the terminal isocyanate groups;
p has a value of 2 to 8; and
R² is a blocking group which is eliminated at a temperature exceeding 100° C.

3. The one-component thermosetting epoxy resin composition as claimed in claim 1, wherein b) at least one 2,4-diamino-1,3,5-triazine GU is a 2,4-diamino-1,3,5-triazine (GU) containing, in the 6 position,
an alkyl radical having 1 to 20 carbon atoms, in which there is a hydrogen atom in the α position; or
an aryl radical having 6 to 12 carbon atoms.

4. The one-component thermosetting epoxy resin composition as claimed in claim 1, wherein the b) at least one 2,4-diamino-1,3,5-triazine GU is selected from the list consisting of 6-nonyl-2,4-diamino-1,3,5-triazine (caprinoguanamine), 6-phenyl-2,4-diamino-1,3,5-triazine (benzoguanamine) and 6-methyl-2,4-diamino-1,3,5-triazine (acetoguanamine).

5. The one-component thermosetting epoxy resin composition as claimed in claim 1, wherein the molar ratio of the molar amount of 2,4-diamino-1,3,5-triazine GU to the molar amount of epoxy groups in the epoxy resin A is 3.8-4.2.

6. The one-component thermosetting epoxy resin composition as claimed in claim 1, wherein
b) at least one 2,4-diamino-1,3,5-triazine GU is a 2,4-diamino-1,3,5-triazine (GU) containing, in the 6 position, an aryl radical having 6 to 12 carbon atoms, and
the one-component thermosetting epoxy resin composition further comprises dicyandiamide.

7. The one-component thermosetting epoxy resin composition as claimed in claim 6, wherein the molar ratio of 2,4-diamino-1,3,5-triazine GU to dicyandiamide is 9.0-2.0.

8. The one-component thermosetting epoxy resin composition as claimed in claim 1, wherein the weight ratio of the at least one epoxy resin A having an average of more than one epoxy group per molecule to the at least one toughness improver D is 0.55-2.4.

9. The one-component thermosetting epoxy resin composition as claimed in claim 8, wherein the weight ratio of the at least one epoxy resin A having an average of more than one epoxy group per molecule to the at least one toughness improver D is 1.0-1.6.

10. The one-component thermosetting epoxy resin composition as claimed in claim 1, wherein the epoxy resin composition includes less than 5% by weight of curing agents for epoxy resins selected from the list consisting of anhydrides of polybasic carboxylic acids and dihydrazides, based on the total weight of the epoxy resin composition.

11. A method of adhesive bonding of heat-stable substrates, comprising the steps of:
a) applying a thermosetting epoxy resin composition as claimed in claim 1 to the surface of a heat-stable substrate S1;
b) contacting the thermosetting epoxy resin composition applied with the surface of a further heat-stable substrate S2;
c) heating the epoxy resin composition to a temperature of 100 to 220° C.;
d) cooling the epoxy resin composition to a temperature of less than 50° C.;
e) reheating the epoxy resin composition to a temperature of 100 to 220° C.;
f) recooling the epoxy resin composition to a temperature of less than 50° C.;
g) reheating the epoxy resin composition to a temperature of 100 to 220° C.

12. The method as claimed in claim 11, wherein, in step c) and in step e), heating the epoxy resin composition, the epoxy resin composition is left at the temperature specified.

13. The method as claimed in claim 11, wherein a local transport step takes place between steps c) and e) and with the composite of the epoxy resin composition with the heat-stable substrates S1 and S2.

14. An adhesive-bonded article obtained from the method as claimed in claim 11.

15. A method of using a thermosetting epoxy resin composition as claimed in claim 1, the method comprising
applying the thermosetting epoxy resin composition as a one-component thermosetting adhesive in vehicle construction or sandwich panel construction.
